(19) United States
(12) Patent Application Publication
(10) Pub. No.: US 2017/0079213 A1
(43) Pub. Date: Mar. 23, 2017

(54) MECHANIZED CULTIVATION SYSTEM AND METHOD TO PRODUCE EDIBLE MUSHROOM

(71) Applicant: Davood Ahmadi, Tehran (IR)

(72) Inventor: Davood Ahmadi, Tehran (IR)

(21) Appl. No.: 15/249,835

(22) Filed: Aug. 29, 2016

(30) Foreign Application Priority Data
Aug. 28, 2015 (IR) 13945014000300609

(51) Int. Cl. A01G 1/04; A01G 7/02; A01G 9/24; A01G 9/18; A01G 1/00; A01G 25/00

(52) U.S. Cl. CPC A01G 1/042; A01G 1/001; A01G 25/00; A01G 9/24; A01G 9/18; A01G 7/02; A01G 9/245

(57) ABSTRACT

A mechanized cultivation system for large scale production of various species of edible mushrooms with controlled CO₂ and humidity and temperature. The system uses a main cultivation cabin which eliminates the need for humans to enter the cabin during cultivation. The produced mushrooms are sterilized and pasteurized inside the cultivation chamber.

### CROSS REFERENCE TO RELATED APPLICATION

This application claims the benefit of priority to an Iran Application Serial Number 139450140003006094 filed on Aug. 28, 2015, which is incorporated by reference herein in its entirety.

### TECHNICAL FIELD

The present disclosure relates generally to the production of edible mushrooms. More specifically, the present application relates to mechanized, large-scale production of edible mushrooms method and apparatus.

### BACKGROUND

People have harvested mushrooms from the wild for thousands of years for food and medicines. Of the estimated 1.5 million species of fungi, about 10,000 produce the fruiting bodies we call mushrooms. While commercial harvesting of wild mushrooms continues today, most of the world's supply comes from commercial mushroom growers. The Chinese first cultivated shiitake (Lentinula edodes) mushrooms around 1100 AD, with domestication efforts beginning centuries earlier. White button mushrooms (Agaricus spp.), most familiar to Americans and Europeans, were first domesticated in France in 1650. Commercial production began in the United States in the 1880s. Agaricus is the leading mushroom crop worldwide and accounted for 99 percent of the 1997 United States' mushroom production. Oyster mushrooms (Pleurotus spp.) were more recently domesticated, and now rank second in world production. Shiitake mushrooms, which are very popular in Asian cultures, rank third. Many other edible mushrooms, such as straw and wood ear mushrooms, are gaining in popularity.

Roughly 300 mushroom species are edible, but only 30 have been domesticated and 10 are grown commercially. Button, oyster, and shiitake mushrooms make up about 70 percent of the world's production. During the past 30 years, mushroom production worldwide increased twenty-fold, with much of that increase occurring in the 1980s and 1990s. Increased demand for specialty mushrooms (everything besides Agaricus) has been particularly strong. Asian countries continue to dominate world production and consumption, however, consumption in the United States has increased sharply in recent years, providing potential opportunities for mushroom growers. As an example, mushroom production in the United States has traditionally centered in Pennsylvania, which produces nearly half the nation's button mushrooms. California and Florida are the second and third leading producers, with limited production in 27 other states. Large-scale growers with established, year-round markets dominate commercial mushroom production. In 1997, 7 percent of United States mushroom farms supplied 20 million pounds or more each, or 38 percent percent of total U.S. production. In contrast, 36 percent of mushroom farms produced less than one million pounds per year.

Shiitake and oyster mushrooms are the best-known specialty mushrooms, and probably the easiest to market. Auricularia spp. (wood ear), Volvariella volvacea (straw mushroom), Flammulina velutipes (enokitake), Grifola frondosa (maitake), and Tremella fuciformis (white jelly or fungus ear) are also increasing in popularity. Volvariella volvacea (straw) mushrooms are the easiest to grow, produce mushrooms in as little as 4 days, and are adapted to areas with high temperatures. They are not as popular with consumers as button, oyster, or shiitake mushrooms, but still account for 6 percent of the world's production. Ganoderma lucidem (reishi), Hericium erinaceus, and Hypsizygus marmoreus (bunashimeji) are medicinal mushrooms used primarily in Asia. Medicinal mushrooms require specialized marketing in every country.

Mushrooms lend themselves to many different growing systems from simple and inexpensive to highly sophisticated and expensive. For outdoor production, log sections are inoculated with spawn (a starter mix of fungal mycelium and sawdust or grain) and set aside to allow the fungi to develop. Shade cloth is often used to protect logs stored outdoors from excessive drying caused by direct sunlight. The development period is called the spawn run and can last 6 to 18 months, depending on the log species, diameter, moisture, and temperature.

At the end of the spawn run, the logs are transferred to a cool, moist raising yard where the mushrooms develop and are harvested. In outdoor systems, most shiitake production occurs in the spring and fall. Greenhouses and converted farm buildings are used to produce winter crops. A single log may bear five crops of mushrooms. Some other mushroom species can also be grown in basic, non-mechanical facilities. Much of the increase in mushroom production is due to the development of high-yield systems that depend on precise environmental controls.

High yields and rapid production cycles with most mushroom species require specialized facilities. Substrates (materials the mushrooms grow in) are blended and packaged into special plastic bags or jars. Typical substrates include sawdust, grain, straw, corn cobs, bagasse, chaff, and other agricultural byproducts.

Containers and substrate are either pasteurized or sterilized to remove contaminating microorganisms. Hot water baths can be used for pasteurization, but sterilization may require a commercial steam sterilizer. Some growers compost substrates outdoors and then sterilize them inside heated sheds.

After being pasteurized or sterilized, the substrate-filled containers are inoculated with the desired fungi and placed into spawn run rooms where temperature, humidity, light, and sometimes atmospheric gases are carefully controlled. When the spawn run is complete, the substrate may need additional treatments before mushrooms develop. Many mushroom species require changes in temperature, moisture, substrate, and/or light to begin fruiting. Large-scale, highly technical facilities are expensive to construct and operate. Whether a basic or sophisticated production system is used, growing mushrooms is labor intensive.

### SUMMARY

The present application discloses a large scale, indoor and mechanized cultivation system to produce various species of edible mushrooms.

Disclosed aspects include a mechanized cultivation system for large scale production of various species of edible mushrooms. The present application discloses a large scale mechanized system for production of edible mushrooms with controlled uniform the CO₂ and humidity. The application eliminates need for labor force. Furthermore, the produce may be sterilized and pasteurized inside the cultivation chamber.

The mechanized cultivation system for production of edible mushrooms includes a main cultivation cabin, a utility cabin and a controller. The main cultivation cabin is an insulated chamber with the dimensions 3 m×4 m×3 m and may include two rows of trays 120 cm×360 cm. Each row may include 5 floors of removable stainless steel and galvanized iron trays of compost blocks. There are 180 sprinklers on two opposite side-walls of the main cultivation cabin which irrigate the compost blocks. The sprinklers are tilted in order to irrigate the compost blocks with an angle equals to 60°.

To provide appropriate aeration for cultivation there are air channels in the middle and on both sides of the trays. The air channels are made of PVC. Furthermore, there is an air mixer to determine the fresh air and recirculated air ratio. An air exhaust on the bottom end of the main cultivation cabin is an outlet for excess air inside the cabin. The humidity, CO₂ concentration and temperature inside the main cultivation cabin are recorded by sensors and the data may be transmitted to the controller.

The utility cabin provides air and desired temperature, humidity, steam and electricity for the main cultivation cabin. The utility cabin is 120 cm×160 cm×130 cm and receives commands from the controller. HEPA filter-equipped air channels inside the utility cabin provide the desired fresh air: recirculated air ratio. The air may be circulated through an air cooler, an air heater and sprinklers to reach the desired temperature and humidity. Afterwards, the air is transmitted to the main cultivation cabin. After circulating inside the main cabin, the air may leave it through the exhaust and return to the utility cabin for further processing. The utility cabin also includes a steamer. The steam may be used for pasteurization of the raw materials, composts, and to rinse and pasteurization of the rows, trays, air mixer, air channels, sensors and the exhaust. The pasteurization process takes 12 hours. The utility cabin may be installed on top of the main cultivation cabin and is made of PVC and galvanized iron.

In a preferred aspect of the present application, the main cultivation cabin does not need to be entered by human workers during cultivation. The elimination of human contact with the pasteurized cultivation environment significantly decreases the risk of contamination of the products. It is also worth mentioning that the cultivation process and pasteurization process are taking place in a same package which reduces the cost of production and contamination.

In another aspect of the present application, the system may be controlled remotely and an operator may control as many as 100 systems simultaneously. Furthermore, the mechanized cultivation system can be configured to produce different species of mushrooms.

### BRIEF DESCRIPTION OF THE DRAWINGS

FIG. 1 is a perspective view of a cultivation chamber according to an implementation of the disclosure.

FIG. 2 is a front view of a controller according to an implementation of the disclosure.

### DETAILED DESCRIPTION

In the following detailed description, various examples are presented to provide a thorough understanding of inventive concepts, and various aspects thereof that are set forth by this disclosure. However, upon reading the present disclosure, it may become apparent to persons of skill that various inventive concepts and aspects thereof may be practiced without one or more details shown in the examples. In other instances, well known procedures, operations and materials have been described at a relatively high-level, without detail, to avoid unnecessarily obscuring description of inventive concepts and aspects thereof.

The large, macroscopic, spore-bearing, fruiting bodies of fungi are generally referred to as mushrooms. Under the proper environmental conditions, their mycelia become tightly interwoven to give rise to the structure we call the mushroom. However, the conditions under which mushrooms form are poorly known. As a result, relatively few species of mushrooms can be cultivated. Today, there are more species of mushrooms cultivated throughout the world than were available in the past. Prior to the 1970s, in Western cultures, only one species, The Button Mushroom, Agaricus bisporus Imbach, was commonly cultivated. This species is grown on a substrate composed of composted horse manure and straw. Most edible mushrooms, available in Western cultures, during this same period, were not cultivated. These species were either collected in wooded areas by individuals for personal consumption or sold to markets for commercial consumption. Because most of the latter species form mycorrhizae, they were usually only available once a year, for a short period of time, during the normal fruiting period for the species. In Eastern cultures, prior to the 1970s, different species were being cultivated. These species were typically those that grew on woody substrate and were cultivated on logs. These included the Shiitakes, Lentinula edodes Pegler, the Wood Ear, Auricularia polytricha. Sacc. and the Enoke, Flammulina velutipes Singer, to name a few. Because the knowledge that fungi reproduced by spores would not be known until the 19th Century, the method initially used in the early cultivation of mushrooms was far different than those carried out today. Early cultivation of mushrooms, involved collecting the fruit bodies of these mushrooms from their natural habitat and taking them to a vicinity of “fresh” substrate, where their spores would germinate and colonize the substrate, eventually giving rise to fruit-bodies. As was the realization that diseases could be passed on from individuals to individuals, it seems likely that the same line of reasoning was applied to growing mushrooms. However, growing mushrooms is not like growing wheat or any other agricultural crop. Even with all the research that has been carried out in mushroom cultivation, the exact conditions under which mushrooms fruit, is still not known for most species. The exact conditions for fruiting even those mushrooms that can be cultivated and are even profitable are still obscure.

Mushrooms are not plants, and require different conditions for optimal growth. Plants develop through photosynthesis, a process that converts atmospheric carbon dioxide into carbohydrates, especially cellulose. While sunlight provides an energy source for plants, mushrooms derive all of their energy and growth materials from their growth medium, through biochemical decomposition processes. This does not mean that light is an irrelevant requirement, since some fungi use light as a signal for fruiting. However, all the materials for growth must already be present in the growth medium. Mushrooms grow well at relative humidity levels of around 95-100%, and substrate moisture levels of 50 to 75%. Instead of seeds, mushrooms reproduce asexually through spores. Spores can be contaminated with airborne microorganisms, which will interfere with mushroom growth and prevent a healthy crop.

Mycelium, or actively growing mushroom culture, is placed on a substrate—usually sterilized grains such as rye or millet—and induced to grow into those grains. This is called inoculation. Inoculated grains are referred to as spawn. Spores are another inoculation option, but are less developed than established mycelium. Since they are also contaminated easily, they are only manipulated in laboratory conditions with a laminar flow cabinet.

Mushrooms can be grown on logs placed outdoors in stacks or piles, as has been done for hundreds of years. Sterilization is not performed in this method. Since production may be unpredictable and seasonal, less than 5% of commercially sold mushrooms are produced this way. Here, tree logs are inoculated with spawn, then allowed to grow as they would in wild conditions. Fruiting, or pinning, is triggered by seasonal changes, or by briefly soaking the logs in cool water. Shiitake and oyster mushrooms have traditionally been produced using the outdoor log technique, although controlled techniques such as indoor tray growing or artificial logs made of compressed substrate have been substituted. Shiitake mushrooms grown under a forested canopy are considered non-timber forest products. Softwood should not be used to cultivate shiitake mushrooms. The resin of softwoods will oftentimes inhibit the growth of the shiitake mushroom making it impractical as a growing substrate.

Indoor growing provides the ability to tightly regulate light, temperature and humidity while excluding contaminants and pests. This allows consistent production, regulated by spawning cycles. This is typically accomplished in windowless, purpose-built buildings, for large scale commercial production. Indoor tray growing is the most common commercial technique, followed by containerized growing. The tray technique provides the advantages of scalability and easier harvesting. Unlike wild harvests, indoor techniques provide tight control over growing substrate composition and growing conditions. Indoor harvests are much more predictable.

Pinning is the trickiest part for a mushroom grower, since a combination of carbon dioxide (CO₂) concentration, temperature, light, and humidity triggers mushrooms towards fruiting. Up until the point when rhizomorphs or mushroom “pins” appear, the mycelium is an amorphous mass spread throughout the growth substrate, unrecognizable as a mushroom.

Carbon dioxide concentration becomes elevated during the vegetative growth phase, when mycelium is sealed in a gas-resistant plastic barrier or bag which traps gases produced by the growing mycelium. To induce pinning, this barrier is opened or ruptured. CO₂ concentration then decreases from about 0.08% to 0.04%, the ambient atmospheric level.

The present application discloses a large scale mechanized system for production of edible mushrooms with controlled uniform the CO₂ and humidity. The application eliminates need for labor force. Furthermore, the produce may be sterilized and pasteurized inside the cultivation chamber.

The mechanized cultivation system for production of edible mushrooms includes a main cultivation cabin, a utility cabin and a controller.

The main cultivation cabin may be an insulated chamber with the dimensions 3 m×4 m×3 m. The main cultivation chamber may include two rows of trays 120 cm×360 cm. Each row may include 5 floors of removable stainless steel and galvanized iron trays of compost blocks. There are 180 sprinklers on two opposite side-walls of the main cultivation cabin which irrigate the compost blocks. The sprinklers are tilted in order to irrigate the compost blocks with an angle equals to 60°.

To provide appropriate aeration for cultivation there are air channels in the middle and on both sides of the trays. The air channels are made of PVC. Furthermore, there is an air mixer to determine the fresh air and recirculated air ratio. An air exhaust on the bottom end of the main cultivation cabin is an outlet for excess air inside the main cultivation cabin. The humidity, CO₂ concentration and temperature inside the main cultivation cabin are recorded by sensors and the data may be transmitted to the controller.

The utility cabin provides air and desired temperature, humidity, steam and electricity for the main cultivation cabin. The utility cabin may be 120 cm×160 cm×130 cm and may receive commands from the controller. HEPA filter-equipped air channels inside the utility cabin provide the desired fresh air: recirculated air ratio. The air may be circulated through an air cooler, an air heater and sprinklers to reach the desired temperature and humidity. Afterwards, the air is transmitted to the main cultivation cabin. After circulating inside the main cultivation cabin, the air may leave the main cultivation cabin through the exhaust and return to the utility cabin for further processing.

The utility cabin also includes a steamer. The steam may be used for pasteurization of the raw materials, composts, and to rinse and pasteurization of the rows, trays, air mixer, air channels, sensors and the exhaust. The pasteurization process takes 12 hours. The utility cabin may be installed on top of the main cultivation cabin and is made of PVC and galvanized iron.

In a preferred aspect of the present application, the main cultivation cabin does not need entering the labor force. The elimination of human contact with the pasteurized cultivation environment significantly decreases the risk of contamination of the products. It is also worth mentioning that the cultivation process and pasteurization process are taking place in a same package which reduces the cost of production and contamination.

In another aspect of the present application, the system may be controlled remotely and an operator may control a plurality of systems simultaneously. Furthermore, the mechanized cultivation system can be configured to produce different species of mushrooms.

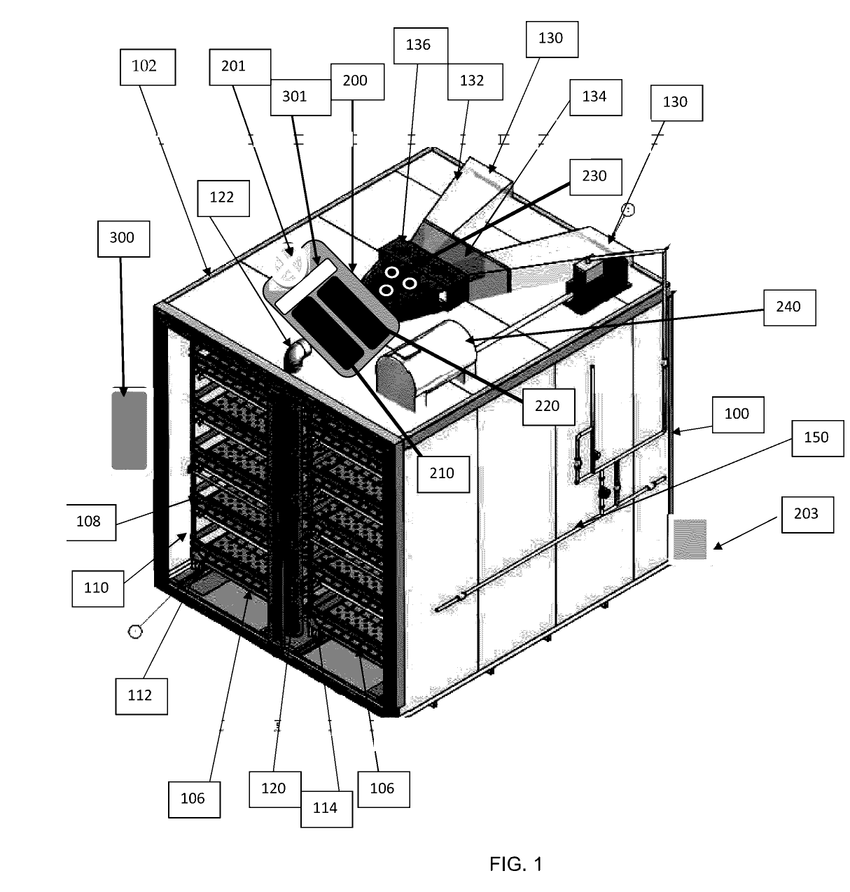

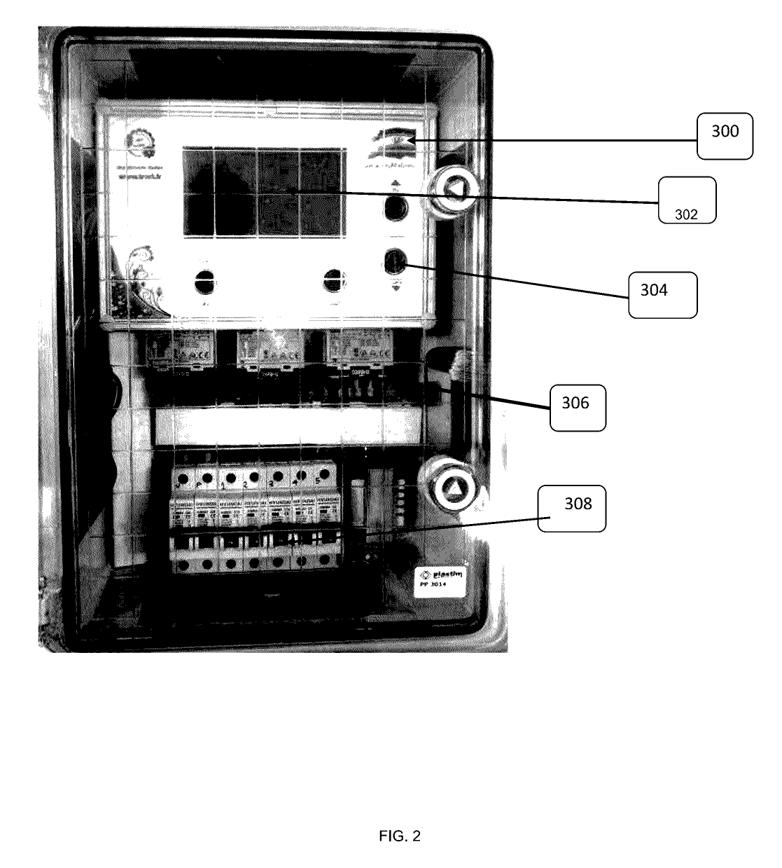

With reference to FIGS. 1 and 2 an example of an implementation of the mechanized cultivation system for production of edible mushrooms will be described. The system includes a main cultivation cabin 100, a utility cabin 200 and a controller 300.

The main cultivation cabin 100 is an insulated chamber 102 with the dimensions 3 m×4 m×3 m, and a door (not shown to permit showing of inside of chamber 102; the door may be hinged to the side of chamber 102 in the front thereof). The main cultivation chamber 102 may include two rows 106 of trays 108 which are each 120 cm×360 cm. The rows 106 have a chassis 110, which can roll on wheels 112 on tracks 114 for entry and exit of the rows 106. The rows 106 may roll off the tracks 114 via ramps or may roll off onto a carrier transit device (not shown). The trays 108 also individually may slide out of the chassis 110. Each row 106 may include 5 floors of the removable stainless steel and galvanized iron trays 108 of compost blocks. There are 180 sprinklers 150 on two opposite side-walls of the main cultivation cabin 100 which irrigate the compost blocks. The sprinklers 150 are tilted in order to irrigate the compost blocks with an angle equals to 60°.

To provide appropriate aeration for cultivation there are air channels 120 in the middle and on both sides (not shown) of the trays 108. The air channels 120 are made of PVC and connect to the utility cabin 200 by PVC such as elbow 122. Furthermore, there is an air mixer 201 in the utility cabin to determine the fresh air and recirculated air ratio. An air exhaust 203 on the bottom end of the main cultivation cabin 100 is an outlet for excess air inside the main cultivation cabin 100. The humidity, CO₂ concentration and temperature inside the main cultivation cabin 100 are recorded by sensors inside and the data may be transmitted to the controller 300. The controller 300 may be on the side of the main cultivation cabin 100 as shown or may be inside the utility cabin 200.

Inlet air to the system is provided by a duct system having air inlets 130, and for example, duct parts 132, 134, and 136, leading into the utility cabin 200.

The utility cabin 200 provides air and desired temperature, humidity, steam and electricity for the main cultivation cabin 100. The utility cabin 200 is 120 cm×160 cm×130 cm and receives commands from the controller 300. HEPA filter-equipped air channels 301 inside the utility cabin 200 provide the desired fresh air to recirculated air ratio. The air may be circulated through an air cooler 210, an air heater 220 and sprinklers 230 to reach the desired temperature and humidity. Afterwards, the air is transmitted to the main cultivation cabin 100. After circulating inside the main cultivation cabin 100, the air may leave the main cultivation cabin through the exhaust and return to the utility cabin for further processing.

The utility cabin also includes a steamer 240. The steam may be used for pasteurization of the raw materials, composts, and to rinse and pasteurization of the rows, trays, air mixer 201, air channels 120, sensors and the exhaust 203. The pasteurization process takes 12 hours. The utility cabin 200 may be installed on top of the main cultivation cabin 100 and is made of PVC and galvanized iron.

FIG. 2 shows an implementation of a controller 300, including a screen 302, control keys 304, on/off switches 306, and fuses 308.

In a preferred aspect of the present application, the main cultivation cabin does not need to be entered by human workers during cultivation. The elimination of human contact with the pasteurized cultivation environment significantly decreases the risk of contamination of the products. It is also worth mentioning that the cultivation process and pasteurization process are taking place in a same package which reduces the cost of production and contamination.

In another aspect of the present application, the system may be controlled remotely by having either the controller 300 be remote controlled or by having the controller interaction wirelessly with the utility cabin 200, and an operator may control a plurality of systems simultaneously. Furthermore, the mechanized cultivation system can be configured to produce different species of mushrooms.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A mechanized and large-scale system for cultivating edible mushrooms comprising:
a main cultivating cabin wherein the mushrooms are being cultivated on trays of compost blocks, wherein a plurality of sensors measuring air conditions are placed inside the main cultivation cabin, and wherein a plurality of sprinklers irrigate the mushrooms with an angle other than normal angle;
a utility cabin wherein desired amount of air for cultivation of mushrooms is adjusted to desired temperature and humidity; and
a controlling cabin wherein the desired amount of air, recirculated air ratio, air temperature and air humidity are being calculated and results of the calculation are sent to the utility cabin to provide the desired air conditions.

2. The system of claim 1, wherein the main cultivation cabin is 3 m×4 m×3 m in dimension.

3. The system of claim 1, wherein the main cultivation cabin further comprises of two rows of 5-floor trays of compost blocks and a plurality of air channels.

4. The system of claim 1, wherein an initial raw material weight inside the main cultivation cabin is approximately 3500 kg.

5. The system of claim 1, wherein there are 180 sprinklers installed on two opposite sides of the main cultivation cabin walls.

6. The system of claim 1, wherein the sprinklers are irrigating the compost blocks with a tilted angle of approximately 60°.

7. The system of claim 1, wherein the trays and the main cultivation cabin are made of stainless steel and galvanized iron.

8. The system of claim 1, wherein there is no need for the labor force to enter the main cultivation cabin during the cultivation process.

9. The system of claim 1, wherein the sensors measure the air humidity, air temperature and CO₂ concentration inside the main cultivation cabin.

10. The system of claim 1, wherein the cultivated mushrooms are pasteurized and sterilized inside the main cultivation cabin.

11. The system of claim 1, wherein the controlling cabin controls the amount of air, fresh air; recirculated air, air temperature, air humidity and CO₂ concentration inside the main cultivation cabin.

12. The system of claim 1, wherein the utility cabin further comprises an air heater, an air cooler, a plurality of sprinklers installed on an air channel for air humidification, an air blower, a plurality of air filters installed on air channels and a hot/cold steamer.

13. The system of claim 1, wherein the utility cabin is installed on top of the main cultivation cabin.

14. The system of claim 1, wherein the utility cabin is approximately 120 cm×160 cm×130 cm in dimension.

15. The system of claim 1, wherein the utility cabin is made of galvanized iron and PVC.

16. The system of claim 1, wherein the pasteurization takes place inside the main cultivation cabin after the cultivation process for 12 hours.

17. A mechanized and large-scale method for cultivating edible mushrooms comprising:
cultivating mushrooms in a main cultivating cabin on trays of compost blocks;
measuring with a plurality of sensors air conditions inside the main cultivation cabin;
sprinkling water using a plurality of sprinklers to irrigate the mushrooms, the sprinking being performed at an angle;
treating air using a utility cabin wherein desired amount of air for cultivation of mushrooms is adjusted to desired temperature and humidity;
calculating via a controller the desired amount of air, fresh air, recirculated air ratio, air temperature and air humidity; and
sending results of the calculating step to the utility cabin to provide the desired air conditions.
